(19) United States
(12) Patent Application Publication
(10) Pub. No.: US 2026/0227805 A1
(43) Pub. Date: Aug. 6, 2026

(54) AUTONOMOUS MOBILE ROBOT CONVEYOR SYSTEM

(71) Applicant: GM Global Technology Operations LLC, Detroit, MI (US)

(72) Inventors: Laura Marcela Gonzales, Birmingham, MI (US); Joshua Lee Solomon, Berkley, MI (US); Jesse Heidrich, Shelby Twp., MI (US); Joel S. Hooton, Chesterfield, MI (US); Kevin K. Parkila, Royal Oak, MI (US); Allan L. Watson, Rochester Hills, MI (US)

(73) Assignee: GM Global Technology Operations LLC, Detroit, MI (US)

(21) Appl. No.: 19/047,553

(22) Filed: Feb. 6, 2025

(51) Int. Cl. G05D 1/695; G05D 1/667; G05D 105/20; G05D 107/70; G05D 109/10; G05D 111/30; H04W 4/46

(52) U.S. Cl. CPC G05D 1/696; G05D 1/667; H04W 4/46; G05D 2105/20; G05D 2107/70; G05D 2109/10; G05D 2111/30

(57) ABSTRACT

A conveyor system, including a first end, a second end spaced from the first end, a ground surface extending between the first end and the second end, and one or more inverted autonomous mobile robots (AMRs) positioned between the first end and the second end, comprising a body, a platform coupled to and supporting the body, a first track coupled to the body, and a second track coupled to the body and spaced from the first track.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to autonomous mobile robots.

Autonomous mobile robots (AMRs) have been designed to move materials within manufacturing facilities and warehouses, playing a crucial role in modern logistics and supply chain management. In general, AMRs can utilize simultaneous localization and mapping (SLAM) and obstacle avoidance to navigate complex environments. By autonomously planning routes and prioritizing tasks, AMRs enhance the operational efficiency of warehouses and manufacturing plants. Their ability to adapt to dynamic environments and coordinate with other robots further optimizes workflow and reduces the need for human intervention.

AMRs help streamline logistics by automating the transportation of goods, thus reducing labor costs and minimizing human error. They can be integrated with Internet of Things (IoT) networks, enabling seamless communication with other devices and systems, such as warehouse management systems (WMS) and manufacturing execution systems (MES). This connectivity allows for real-time data exchange and improved decision-making processes. Further development and utilization of AMRs are possible and will be discussed in accordance with principles of the present disclosure.

### SUMMARY

In one configuration, a conveyor system is provided and includes a first end, a second end spaced from the first end, a ground surface extending between the first end and the second end, and one or more inverted autonomous mobile robots (AMRs) positioned between the first end and the second end, including a body, a platform coupled to and supporting the body, a first track coupled to the body, and a second track coupled to the body and spaced from the first track.

The conveyor system may include one or more of the following optional aspects. For example, the platform may directly contact the ground surface. The platform can include one or more through holes that are configured to receive one or more fasteners for fastening the platform to the ground surface.

According to at least one aspect, the one or more inverted AMRs include one or more spacers arranged between and coupled to the platform and the body to define one or more openings.

According to another aspect, the first track and the second track may be configured to move in a first direction, a second direction, and in directions that are opposite of one another.

In another configuration, a conveyor system is provided and includes a first end, a second end spaced from the first end, a ground surface extending between the first end and the second end, one or more cradles arranged on the ground surface between the first end and the second end, and one or more inverted autonomous mobile robots (AMRs) each positioned in one of the one or more cradles between the first end and the second end. The one or more inverted AMRs each include a body having a first side, a second side spaced from the first side with respect to a longitudinal axis, a first end, and a second end spaced from the first end with respect to a lateral axis that is arranged perpendicular to the longitudinal axis, a platform coupled to and supporting the body, a first track coupled to the body, and a second track coupled to the body.

The conveyor system may include one or more of the following optional aspects. For example, the one or more cradles may constrain each of the AMRs with respect to the longitudinal axis and the lateral axis.

According to at least one aspect, the one or more cradles may each include one or more through holes. The conveyor system may further include one or more fasteners arranged in the one or more through holes of the cradles and secured to the ground surface. Each of the one or more inverted AMRs may be secured to the one or more cradles with the one or more fasteners.

In another configuration, a conveyor system for manufacturing a vehicle is provided and includes a first end, a second end spaced from the first end, a ground surface extending between the first end and the second end, one or more first segments including one or more inverted autonomous mobile robots (AMRs) coupled to the ground surface, and one or more second segments including one or more non-inverted AMRs movable about the ground surface and communicatively coupled to the one or more inverted AMRs.

The conveyor system may include one or more of the following optional aspects. For example, the one or more inverted AMRs may be secured to the ground surface with one or more fasteners. The one or more non-inverted AMRs can include treaded tracks that engage with the ground surface.

According to at least one aspect, the one or more inverted AMRs may be positioned to guide an object to a first path or to a second path arranged adjacent to the first path.

According to another aspect, the one or more inverted AMRs may be positioned to guide an object in a first direction between the first end and the second end. The one or more inverted AMRs can be positioned to guide the object in a second direction that is perpendicular to the first direction.

According to at least one example, the one or more non-inverted AMRs may be configured to retrieve an object from one of the one or more first segments. The non-inverted AMRs can be configured to move the object about a central axis.

According to another example, the one or more inverted AMRs may each include a power reservoir and a vehicle management system. The power reservoir and the vehicle management system of each of the one or more inverted AMRs may be communicatively coupled to one another.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle according to principles of the present disclosure;

FIG. 2 is a front perspective view of an autonomous mobile robot (AMR) according to the principles of the present disclosure;

FIG. 3 is a side view of the AMR of FIG. 2;

FIG. 4 is a side view of the AMR of FIG. 2 coupled to a ground surface;

FIG. 5 is a side view of the AMR of FIG. 2 arranged in a cradle that is coupled to the ground surface;

FIG. 6 is a perspective view of a conveyor system according to the principles of the present disclosure;

FIG. 7 is a side view of the conveyor system of FIG. 6; and

FIG. 8 is an overhead view of another configuration of a conveyor system according to the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

At least some of the principles of the present disclosure provide a conveyor system that can be rapidly deployed and reconfigured as needed within an operating environment. The conveyor system relies on one or more inverted autonomous mobile robots (AMRs) to move objects between a first end and a second end. More particularly, the wheels or treaded tracks of one AMR can provide support, position, and/or move (i.e., convey) objects to neighboring AMRs.

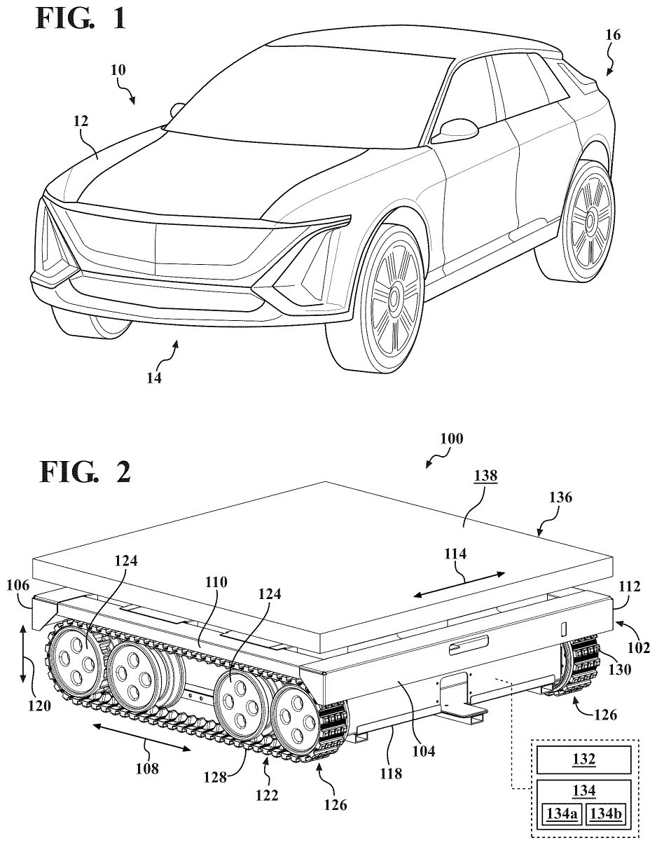

With reference to FIG. 1, an illustrative example of a vehicle 10 is provided. The vehicle 10 has a vehicle body 12 extending between a first end 14 and a second end 16. Production of the vehicle 10 can include the use of one or more autonomous mobile robots (AMRs) 100. Incorporating one or more AMRs 100 can offer numerous benefits, such as increased efficiency and productivity. By handling material transportation, supporting assembly lines, managing inventory, performing quality control, collaborating with human workers, providing flexibility, and collecting data, AMRs 100 can contribute significantly to the advancement of vehicle manufacturing.

With reference to FIG. 2, an illustrative example of the AMR 100 is provided. The AMR 100 has a body 102 that includes a first end 104 and a second end 106 spaced from the first end 104 with respect to a longitudinal axis (i.e., a longitudinal direction) 108, a first side 110 and a second side 112 spaced from the first side 110 with respect to a lateral axis (i.e., a lateral direction) 114, and a top side 116 and a bottom side 118 spaced from the top side 116 with respect to a vertical axis (i.e., a vertical direction) 120. The AMR 100 includes a suspension and propulsion system 122 that is configured so that the AMR 100 can move (i.e., traverse) throughout an operating environment (e.g., an industrial space). In the present illustrative example, one or more wheel hubs 124 are coupled to the first and second sides 110, 112 of the body 102 of the AMR 100 and are configured to engage with and drive treaded tracks 126 arranged on the wheel hubs 124. The treaded tracks 126 include a first track 128 arranged adjacent to the first side 110 of the body 102 and a second track 130 arranged adjacent to the second side 112 of the body 102. More particularly, the first track 128 and the second track 130 can be arranged parallel to the longitudinal axis 108. The first track 128 and the second track 130 can both rotate about the wheel hubs 124 in the same direction to move the AMR 100 in a first direction (i.e., forward) or a second direction (i.e., reverse). The first track 128 and the second track 130 can also move opposite of one another so that the AMR 100 turns clockwise or counterclockwise, for example. The treaded tracks 126 provide maneuverability and stability that allow the AMR 100 to traverse uneven terrain, similar to heavy duty or construction equipment. The treaded tracks 126 can be selected based on obstacles (e.g., cracks in the floor, bolts and screws, etc.) and surfaces commonly encountered throughout an industrial space, for example. The treaded tracks (e.g., serpentine belts, cross track tread, longitudinal treads, etc.) can be various sizes (i.e., widths) depending on the application. Note, the principles of the present disclosure equally apply to AMRs that have omnidirectional wheels or wheels other than the treaded tracks 126.

The AMR 100 can include a power reservoir (i.e., a battery) 132 that supplies power to the suspension and propulsion system 122 and to a vehicle management system 134. The vehicle management system 134 can include a communication system (i.e., computing hardware and memory hardware) 134a and a sensor system 134b. The vehicle management system 134 enables navigation and operation of the AMR 100 for autonomous movement throughout the operating environment. More particularly, the vehicle management system 134 can rely on sensor data, algorithms, and/or artificial intelligence to help navigate throughout the operating environment. According to one aspect, the vehicle management system 134 can be configured to communicate with neighboring AMRs so that the treaded tracks 126 of each AMR can be synchronously controlled.

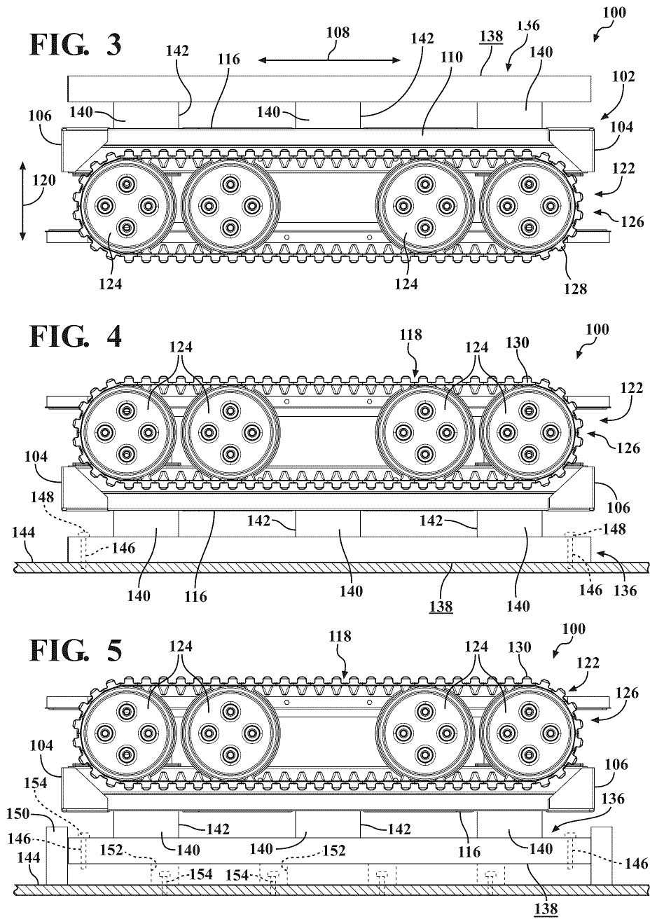

With reference to FIGS. 2 and 3, the AMR 100 can further include a platform 136 coupled to the top side 116 of the body 102. The platform 136 can include a flat surface 138 that is spaced from the top side 116 of the body 102 and can be configured to support one or more items (e.g., pallets, crates, etc.). According to one aspect, the platform 136 can be coupled to the body 102 with one or more spacers 140 between the platform 136 and the top side 116 to define one or more openings 142 that extend between the first side 110 and the second side 112. The openings 142 can be configured to receive a fork of a forklift or another device found in a manufacturing or industrial facility that is capable of manipulating the orientation of the AMR 100. As will be discussed in greater detail below, the openings 142 are desirable so that an operator can engage with and invert the AMR 100 such that the platform 136 engages (i.e., directly or indirectly) with a ground surface (i.e., ground) 144 of the operating environment. With reference to FIGS. 4 and 5, the platform 136 can include one or more through holes 146 so that the AMR 100 can be secured to the ground 144 within the operating environment.

With reference to FIG. 4, the AMR 100 can be inverted (i.e., arranged upside down) so that at least a portion of the flat surface 138 contacts the ground surface 144 of the operating environment. One or more fasteners 148 can be inserted into the through holes 146 with respect to the vertical axis 120 (FIG. 3) and fastened to the ground 144 of the operating environment. Other methods of securing the AMR 100 to the ground 144 of the operating environment are possible as well. For instance, in one configuration, a cradle or nest 150 configured to receive the AMR 100 can be coupled to the ground 144. The cradle 150 can include one or more through holes 152 that are configured to receive one or more fasteners 154. The cradle 150 can be configured to constrain the AMR 100 longitudinally and laterally. The fasteners 154 can also be inserted through one or more of the through holes 146 to further secure the AMR 100 to the cradle 150. According to one aspect, the AMR 100 can be fastened or secured to the cradle 150 in a manner that allows the AMR 100 to be easily interchanged or swapped out with another AMR.

When the AMR 100 is positioned so that the platform 136 contacts (i.e., directly or indirectly) the ground surface 144, the treaded tracks 126 are suspended or spaced away from the ground surface 144 such that the first track 128 and the second track 130 can move without changing the position of the AMR 100. In other words, the AMR 100 can be referred to as a conveyor when the platform 136 contacts (i.e., directly or indirectly) the ground surface 144. The first track 128 and the second track 130 can both be driven in the first direction (i.e., forward), the second direction (i.e., reverse), or in directions that are opposite of one another. Objects (e.g., pallets) or materials can be placed on one or both of the treaded tracks 126 and can be moved via synchronous or independent movement of the treaded tracks 126.

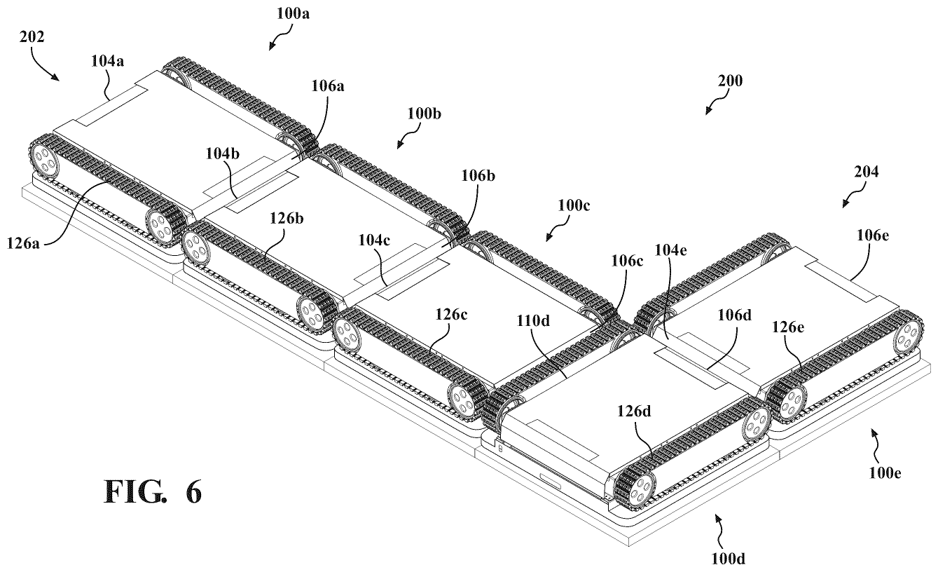

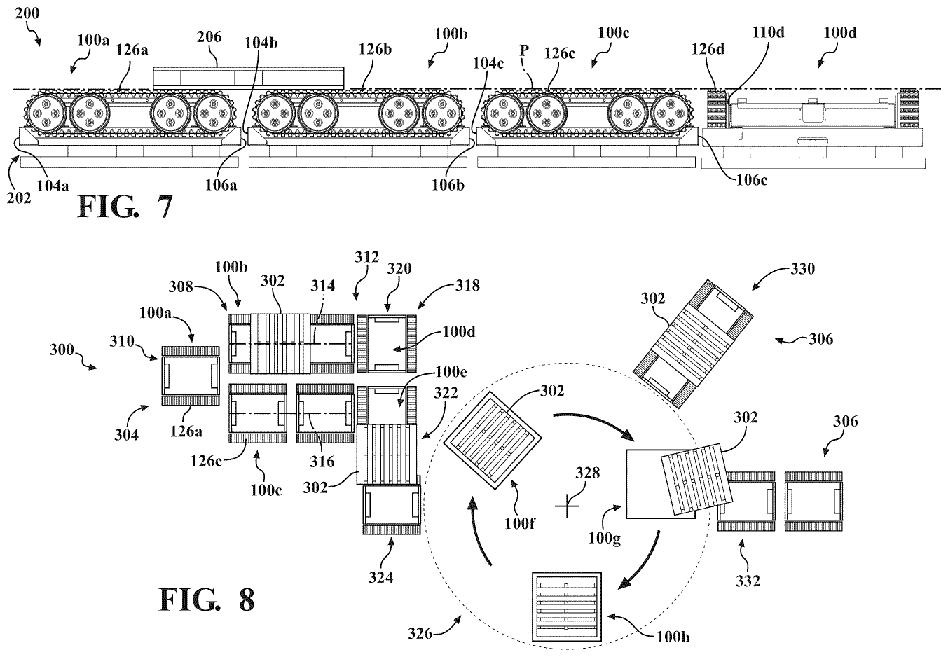

FIGS. 6-7 illustrates an illustrative configuration of a conveyor system 200. This configuration is similar in many respects to the configuration of FIGS. 1-5. Accordingly, the descriptions of the configurations are hereby incorporated into one another, and description of subject matter common to the configurations generally may not be repeated.

With reference to FIG. 6, the conveyor system 200 is provided and includes several of the AMRs 100 arranged with respect to one another. In general, the AMRs 100 can be arranged in a variety of configurations for manipulating (e.g., rotating, shifting, etc.) and moving (i.e., transporting) objects (e.g., pallets) or materials between a first end 202 and a second end 204. In other words, the conveyor system 200 can be configured to include segments that impart linear movement, turntable movement, diverging movement, and/or angled movement. The conveyor system 200 can also include one or more segments that are configured to rotate or orient objects and/or materials in place. The suspension and propulsion system 122 is configured to provide traction and control for linear travel, precise turns, and manipulation of objects and materials between the first end 202 and the second end 204.

With continued reference to FIG. 6, the conveyor system 200 includes several AMRs 100a-e that are arranged adjacent to one another between the first end 202 and the second end 204. With reference to FIG. 7, a first end 104a of a first AMR 100a defines at least a portion of the first end 202 of the conveyor system 200. A second end 106a of the first AMR 100a is arranged adjacent to a first end 104b of a second AMR 100b. The second end 106b of the second AMR 100b is arranged adjacent to a first end 104c of a third AMR 100c. A second end 106c is arranged adjacent to a first side 110d of a fourth AMR 100d. A second end 106d of the fourth AMR 100d is arranged adjacent to a first end 104e of a fifth AMR 100e. A second end 106e of the fifth AMR 100e defines at least a portion of the second end 204 of the conveyor system 200. Treaded tracks 126a-e arranged on the AMRs 100a-e all share a plane P so that objects 206 can easily transition from one AMR to another.

With reference to FIG. 6, the AMRs 100a-e of the conveyor system 200 may be communicatively coupled together as a daisy chain for operational power and for charging. This can be desirable because the AMRs 100a-e of the conveyor system 200 can still operate even if a battery of one of the AMRs 100a-e is depleted. Linearly connecting the AMRs 100a-e to one another can allow at least one of the AMRs 100a-e to leverage power and data communication from at least one of the neighboring AMRs 100a-e. According to one aspect, the AMRs 100a-e can each communicate with one another and with infrastructure arranged within the operating environment.

FIG. 8 illustrates another illustrative configuration of a conveyor system 300. This configuration is similar in many respects to the configurations of FIGS. 1-5 and FIGS. 6-7. Accordingly, the descriptions of the configurations are hereby incorporated into one another, and description of subject matter common to the configurations generally may not be repeated.

With reference to FIG. 8, the conveyor system 300 includes several AMRs 100 arranged in segments that are configured to manipulate or move one or more objects or materials 302 between a first end 304 and a second end 306. The conveyor system 300 can include a first or diverging lines segment 308 that defines at least a portion of the first end 304. The diverging lines segment 308 includes a first end 310 and a second end 312 spaced from the first end 310. One of the objects 302 can be placed on or otherwise engage with treaded tracks 126a of a first AMR 100a arranged at the first end 310 and begin to move toward the second end 312. A second AMR 100b and a third AMR 100c can be arranged adjacent to one another and adjacent to the first AMR 100a, as shown in FIG. 8. As the object 302 moves along the treaded tracks 126a of the first AMR 100a, the object 302 will eventually contact the treaded tracks 126b, 126c of the second AMR 100b and/or the third AMR 100c and begin to pull or gravitate toward the second AMR 100b to a first path 314 or toward the third AMR 100c to a second path 316. The first path 314 and the second path 316 both lead the object 302 toward the second end 312 of the diverging lines segment 308 and to a second or orthogonal segment 318 arranged adjacent to the second end 312. The orthogonal segment 318 can include a first end 320 and a second end 322 spaced from the first end 320. The first end 320 can be defined by one or more AMRs (e.g., a fourth AMR 100d and a fifth AMR 100e) that are arranged adjacent to the first path 314 and the second path 316. The fourth AMR 100d and the fifth AMR 100e can be configured to receive objects 302 from the first path 314 and the second path 316 and move the objects 302 in a direction arranged 90 degrees from the first path 314 and the second path 316. The conveyor system 300 can include a third segment 324 that is arranged at the second end 322 of the orthogonal segment 318 and can be configured to move the object 302 in a direction that is arranged 90 degrees from the orthogonal segment 318. In other words, the third segment 324 can be configured to move the object 302 in a direction that is generally parallel to that of the first path 314 and the second path 316. The conveyor system 300 can include a fourth or turntable segment 326 that is configured to move the objects 302 about a central axis 328. In one configuration, the turntable segment 326 can include a single turntable that is configured to receive the objects 302 from the third segment 324 and move (i.e., rotate) the objects 302 about the central axis 328 to a fifth segment 330 or a sixth segment 332 of the conveyor system 300. In another configuration, the turntable segment 326 can include one or more non-inverted AMRs 100f-h. In other words, the treaded tracks 126 of the AMRs 100f-h are engaged with the ground 144 and are configured to autonomously receive one of the objects 302 on the flat surface 138 of the platform 136 as the objects 302 depart the third segment 324. The non-inverted AMRs 100f-h can be configured to move or carry the objects 302 about the central axis 328 to the fifth segment 330 and/or the sixth segment 332 of the conveyor system 300.

The conveyor system 300 is simply one possible configuration of the AMRs and it should be noted that other configurations including one or more of the segments introduced above are possible.

The preceding configurations are illustrative and it must be notes that AMRs 100 can be inverted and arranged in a countless number of configurations that help move objects between one or more starting points and one or more ending points. The principles of the present disclosure provide a basis for inverting one or more AMRs 100 and utilizing the treaded track to move one or more objects. This can be desirable to improve efficiency and productivity when manufacturing vehicles as well as number of other products.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A conveyor system, comprising:
a first end;
a second end spaced from the first end;
a ground surface extending between the first end and the second end; and
one or more inverted autonomous mobile robots (AMRs) positioned between the first end and the second end, comprising:
a body,
a platform coupled to and supporting the body,
a first track coupled to the body, and
a second track coupled to the body and spaced from the first track.

2. The conveyor system of claim 1, wherein the platform directly contacts the ground surface.

3. The conveyor system of claim 2, wherein the platform includes one or more through holes that are configured to receive one or more fasteners for fastening the platform to the ground surface.

4. The conveyor system of claim 1, wherein the one or more inverted AMRs include one or more spacers arranged between and coupled to the platform and the body to define one or more openings.

5. The conveyor system of claim 1, wherein the first track and the second track are configured to move in a first direction, a second direction, and in directions that are opposite of one another.

6. A conveyor system, comprising:
a first end;
a second end spaced from the first end;
a ground surface extending between the first end and the second end;
one or more cradles arranged on the ground surface between the first end and the second end; and
one or more inverted autonomous mobile robots (AMRs) each positioned in one of the one or more cradles between the first end and the second end, comprising:
a body, comprising:
a first side,
a second side spaced from the first side with respect to a longitudinal axis,
a first end, and
a second end spaced from the first end with respect to a lateral axis that is arranged perpendicular to the longitudinal axis,
a platform coupled to and supporting the body,
a first track coupled to the body, and
a second track coupled to the body.

7. The conveyor system of claim 6, wherein the one or more cradles constrain each of the AMRs with respect to the longitudinal axis and the lateral axis.

8. The conveyor system of claim 6, wherein the one or more cradles each include one or more through holes.

9. The conveyor system of claim 8, further including one or more fasteners arranged in the one or more through holes of the cradles and secured to the ground surface.

10. The conveyor system of claim 9, wherein each of the one or more inverted AMRs are secured to the one or more cradles with the one or more fasteners.

11. A conveyor system for manufacturing a vehicle comprising:
a first end;
a second end spaced from the first end;
a ground surface extending between the first end and the second end;
one or more first segments including one or more inverted autonomous mobile robots (AMRs) coupled to the ground surface; and
one or more second segments including one or more non-inverted AMRs movable about the ground surface and communicatively coupled to the one or more inverted (AMRs).

12. The conveyor system of claim 11, wherein the one or more inverted AMRs are secured to the ground surface with one or more fasteners.

13. The conveyor system of claim 12, wherein the one or more non-inverted AMRs include treaded tracks that engage with the ground surface.

14. The conveyor system of claim 11, wherein the one or more inverted AMRs are positioned to guide an object to a first path or to a second path arranged adjacent to the first path.

15. The conveyor system of claim 11, wherein the one or more inverted AMRs are positioned to guide an object in a first direction between the first end and the second end.

16. The conveyor system of claim 15, wherein the one or more inverted AMRs are positioned to guide the object in a second direction that is perpendicular to the first direction.

17. The conveyor system of claim 11, wherein the one or more non-inverted AMRs are configured to retrieve an object from one of the one or more first segments.

18. The conveyor system of claim 17, wherein the non-inverted AMRs are configured to move the object about a central axis.

19. The conveyor system of claim 11, wherein the one or more inverted AMRs each include a power reservoir and a vehicle management system.

20. The conveyor system of claim 19, wherein the power reservoir and the vehicle management system of each of the one or more inverted AMRs are communicatively coupled to one another.
